(19) United States
(12) Patent Application Publication
(10) Pub. No.: US 2011/0168205 A1
(43) Pub. Date: Jul. 14, 2011

(54) SUBSTRATE CLEANING METHOD AND SUBSTRATE CLEANING APPARATUS

(75) Inventors: Shigeru TAHARA, Nirasaki-shi (JP); Fumiko YAMASHITA, Nirasaki-shi (JP); Eiichi NISHIMURA, Nirasaki-shi (JP); Tokuhisa OHIWA, Yokkaichi-shi (JP); Takaya MATSUSHITA, Yokkaichi-shi (JP); Hiroshi TOMITA, Yokohama-shi (JP)

(73) Assignees: TOKYO ELECTRON LIMITED, Tokyo (JP); KABUSHIKI KAISHA TOSHIBA, Tokyo (JP)

(21) Appl. No.: 12/985,652

(22) Filed: Jan. 6, 2011

(30) Foreign Application Priority Data
Jan. 8, 2010 (JP) P2010-002720

(51) Int. Cl. B08B 7/00; C23F 1/08

(52) U.S. Cl. 134/1.1; 156/345.1

(57) ABSTRACT

A substrate cleaning method performing cleaning of a surface of a substrate after a pattern on the substrate is formed by plasma etching, includes: a by-product removal process removing a by-product by exposing the substrate to an HF gas atmosphere; and a residual fluorine removal process removing fluorine remaining on the substrate by turning cleaning gas containing hydrogen gas and chemical compound gas containing carbon and hydrogen as constituent elements into plasma to act on the substrate.

### CROSS-REFERENCE TO RELATED APPLICATIONS

This application is based upon and claims the benefit of priority from the prior Japanese Patent Application No. 2010-002720, filed on Jan. 8, 2010; the entire contents of which are incorporated herein by reference.

### BACKGROUND

1. Field

The present invention relates to a substrate cleaning method and a substrate cleaning apparatus.

2. Description of the Related Art

Conventionally, formations of micropatterns having various structures are performed by a plasma etching process in a manufacturing field of a semiconductor device. There is a case when a by-product is generated in the plasma etching process as stated above, and a cleaning process to remove the by-product is performed after the plasma etching process.

As a technology to etch silicon in the plasma etching technology, a technology is known in which a native oxide film on a silicon surface is removed by plasma of SF₆ gas at a first step, residual fluorine is removed by plasma of hydrogen gas at a second step, and silicon is etched by using plasma of HCL and O₂ at a third step (for example, refer to JP-A 08-264507 (KOKAI)).

As a technology of cleaning a processing chamber where plasma etching is performed by gas containing halogen, for example, a technology is known in which plasma cleaning is performed by hydrogen gas and so on in addition to oxygen gas and halogen gas as cleaning gas (for example, refer to JP-A 08-055838 (KOKAI)).

A technology is known in which fluorine remaining on a surface of a titanium nitride film or a tungsten film is removed by heating a semiconductor substrate in a gas atmosphere containing hydrogen such as vapor after plasma etching using gas containing fluorine atoms (for example, refer to JP-A 10-163127 (KOKAI)).

### SUMMARY

When a pattern including an exposed part of a silicon layer such as a pattern having a structure in which the silicon layer and an insulating film layer are laminated is formed by plasma etching and so on, there is a case when a by-product of which main constituent is SiO is adhered on a pattern surface when the plasma etching is performed. The by-product of which main constituent is SiO can be removed by a vapor phase removal using fluorine based gas such as HF gas, but in this case, fluorine remains on the pattern surface. When the pattern is left under a state in which fluorine remains, there is a problem that a defect occurs at the pattern because the residual fluorine reacts with the silicon layer.

As a method for removing the residual fluorine, it is known that water washing is effective. However, for example, in case of a micropattern of 36 nm or less, it turns out that there is a case when the pattern is broken caused by a capillary force under drying step after the water washing is performed, as a result of detailed investigation of the present inventors and so on. Besides, for example, an effect of the removal of the fluorine remaining at the pattern is seldom obtained by a heat treatment at approximately 200° C., or a process heating at approximately 50° C. to 150° C. and exposing to vapor, and so on. Further, a problem occurs in which the silicon layer is scraped by hydrogen plasma if the removal of the residual fluorine is performed by exposing to the plasma of the hydrogen gas.

As stated above, technologies are conventionally known in which a native oxide film is removed by fluorine based gas, and residual fluorine is removed by water washing and the plasma of the hydrogen gas and so on, in the plasma etching technology. However, there is no technology capable of performing the removal of the by-product and the removal of the residual fluorine without damaging the pattern when the pattern including the exposed part of the silicon layer such as the pattern having the structure in which the silicon layer and the insulating film layer are laminated is formed by the plasma etching.

An object of the present invention is to provide a substrate cleaning method and a substrate cleaning apparatus capable of performing the removal of the by-product and the removal of the residual fluorine without damaging the pattern when the pattern including the exposed part of the silicon layer is formed by the plasma etching.

An aspect of a substrate cleaning method according to the present invention, performing cleaning of a surface of a substrate after a pattern on the substrate is formed by plasma etching, includes: performing a by-product removal process removing a by-product by exposing the substrate to an HF gas atmosphere; and performing a residual fluorine removal process removing fluorine remaining on the substrate by turning cleaning gas containing hydrogen gas and chemical compound gas containing carbon and hydrogen as constituent elements into plasma to act on the substrate.

An aspect of a substrate cleaning apparatus according to the present invention, performing cleaning of a surface of a substrate after a pattern on the substrate is formed by plasma etching, includes: a by-product removal unit removing a by-product by exposing the substrate to an HF gas atmosphere; and a residual fluorine removal unit removing fluorine remaining on the substrate by turning cleaning gas containing hydrogen gas and chemical compound gas containing carbon and hydrogen as constituent elements into plasma to act on the substrate.

### BRIEF DESCRIPTION OF THE DRAWINGS

FIG. 1 is a longitudinal sectional view schematically illustrating a configuration example of a gas processing apparatus according to an embodiment of the present invention.

FIG. 2 is a longitudinal sectional view schematically illustrating a configuration example of a plasma processing apparatus according to an embodiment of the present invention.

FIG. 3 is a view schematically illustrating a configuration example of a substrate cleaning apparatus according to an embodiment of the present invention.

FIG. 4 is a graphic chart representing a measurement result of a fluorine amount by comparison.

FIG. 5 is a graphic chart representing a measurement result of XPS.

FIG. 6 is a view enlarged and schematically illustrating a pattern in which damage occurs at a silicon layer.

### DETAILED DESCRIPTION

Hereinafter, embodiments of the present invention are described with reference to the drawings.

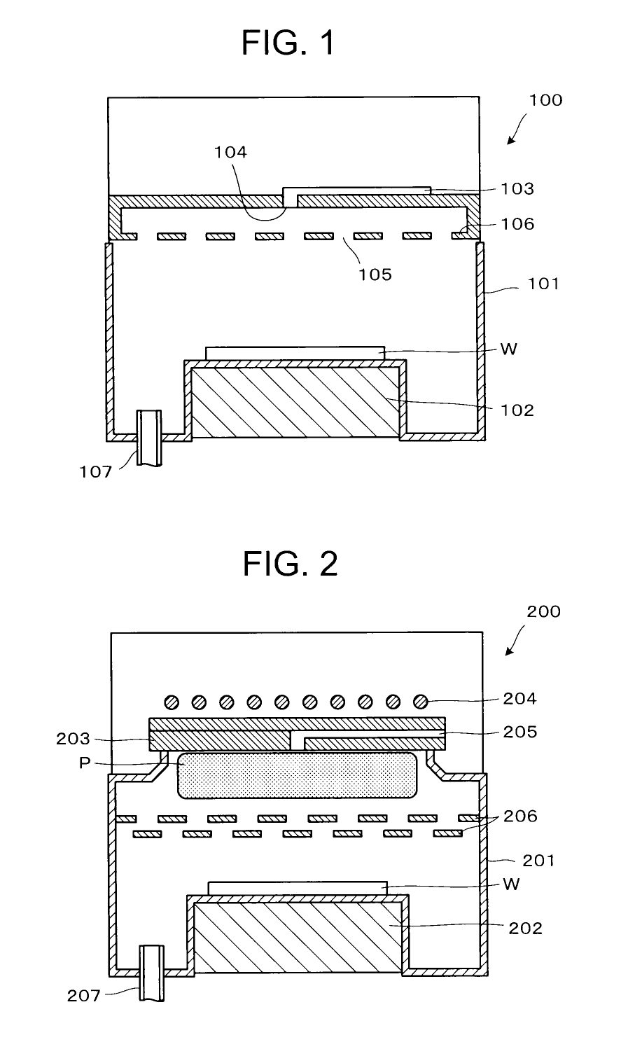

FIG. 1 is a longitudinal sectional view schematically illustrating a configuration example of a gas processing apparatus 100 used for a by-product removal process of an embodiment of the present invention. As illustrated in FIG. 1, the gas processing apparatus 100 includes a processing chamber 101 of which inside is air-tightly closable. A stage 102 is provided inside the processing chamber 101 to mount a semiconductor wafer (substrate) W. The stage 102 includes a not-illustrated temperature control mechanism, and it is possible to maintain a temperature of the semiconductor wafer W mounted on the stage 102 at a predetermined temperature.

A gas introducing part 103 for introducing predetermined processing gas (HF gas in this embodiment) into the processing chamber 101 is provided at an upper portion of the processing chamber 101. A gas diffusion plate 106 in which a number of through holes 105 are formed is provided downward of an opening part 104 where the gas introducing part 103 opens into the processing chamber 101. The HF gas is supplied from these through holes 105 of the gas diffusion plate 106 to a surface of the semiconductor wafer W under a state diffused evenly.

An exhaust pipe 107 is provided at a bottom part of the processing chamber 101. This exhaust pipe 107 is connected to a not-illustrated vacuum pump and so on, and it is possible to exhaust inside the processing chamber 101 to be a predetermined pressure.

FIG. 2 is a longitudinal sectional view schematically illustrating a configuration example of a plasma processing apparatus 200 used for a residual fluorine removal process of an embodiment of the present invention. As illustrated in FIG. 2, this plasma processing apparatus 200 includes a processing chamber 201 of which inside is air-tightly closable. A stage 202 is provided inside the processing chamber 201 to mount the semiconductor wafer (substrate) W. The stage 202 includes a not-illustrated temperature control mechanism, and it is possible to maintain a temperature of the semiconductor wafer W mounted on the stage 202 at a predetermined temperature.

The processing chamber 201 is made up of, for example, quartz and so on, and a window 203 made of quartz is formed at a ceiling part thereof. An RF coil 204 connected to a not-illustrated high-frequency power supply is provided at outside of the window 203. A gas introducing part 205 for introducing predetermined cleaning gas (for example, H₂+CH₄+Ar) into the processing chamber 201 is provided at a part of the window 203. Plasma P of the cleaning gas introduced from the gas introducing part 205 is generated by an operation of high frequency supplied to the RF coil 204.

A gas diffusion plate 206 to block plasma and diffuse gas is provided downward of the window 203. Radical in the plasma is supplied to the semiconductor wafer W on the stage 202 under a diffused state via the gas diffusion plate 206. Note that when the plasma is to be acted on the substrate, the substrate and the plasma may be directly brought into contact. Otherwise, the substrate and the plasma are not directly brought into contact but a process by remote plasma, namely, the radical extracted from the plasma generated at a portion separated from the substrate is acted on the substrate, as in the present embodiment.

Besides, an exhaust pipe 207 is provided at a bottom part of the processing chamber 201. This exhaust pipe 207 is connected to a not-illustrated vacuum pump and so on, and it is possible to exhaust inside the processing chamber 201 to be a predetermined pressure.

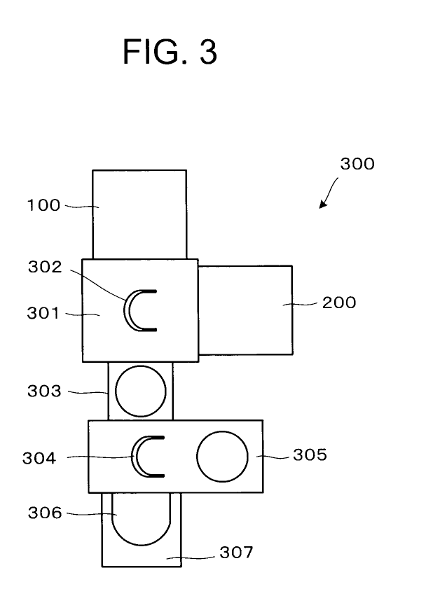

FIG. 3 is a view illustrating a configuration of a cleaning processing apparatus 300 in which the gas processing apparatus 100 and the plasma processing apparatus 200 having the above-stated constitutions are integrated. As illustrated in FIG. 3, the gas processing apparatus 100 and the plasma processing apparatus 200 are connected via a vacuum transfer chamber 301, and a vacuum transfer mechanism 302 to transfer the semiconductor wafer W under a vacuum atmosphere is arranged inside the vacuum transfer chamber 301. Not-illustrated opening/closing mechanisms (gate valve and so on) are respectively provided between the vacuum transfer chamber 301 and the gas processing apparatus 100, and between the vacuum transfer chamber 301 and the plasma processing apparatus 200.

A load lock chamber 303 is connected to the vacuum transfer chamber 301. The semiconductor wafer W is carried in, and carried out of the vacuum transfer chamber 301 via the load lock chamber 303. A transfer mechanism 304 to transfer the semiconductor wafer W under an atmospheric pressure atmosphere is arranged at outside of the load lock chamber 303. An aligner 305 to perform a positioning of the semiconductor wafer W, and a load port 307 on which a FOUP (or a cassette) 306 housing the semiconductor wafer W is mounted are arranged at a periphery of the transfer mechanism 304.

Cleaning of the semiconductor wafer W is performed as described below in this embodiment by using the cleaning processing apparatus 300 having the above-stated constitution.

The FOUP (or the cassette) 306 housing the semiconductor wafer W is mounted on the load port 307 of the cleaning processing apparatus 300. A pattern including the exposed part of the silicon layer is formed on the semiconductor wafer W in the plasma etching process being a preceding process.

The semiconductor wafer W inside the FOUP 306 is pulled out by the transfer mechanism 304, at first transferred to the aligner 305, and the positioning of the semiconductor wafer W is performed here. The positioning by the aligner 305 is performed by a publicly known method or the like in which positions of peripheral edge parts of the semiconductor wafer W and a position of a notch are detected while rotating the semiconductor wafer W. After that, the semiconductor wafer W is transferred into the load lock chamber 303.

The semiconductor wafer W is transferred into the load lock chamber 303, a transfer arm of the transfer mechanism 304 retreats from the load lock chamber 303, and thereafter, the opening/closing mechanism (not-illustrated) at an atmosphere side of the load lock chamber 303 is closed. Next, exhaust is performed until inside the load lock chamber 303 reaches a predetermined degree of vacuum. After that, the opening/closing mechanism (not-illustrated) at a vacuum side of the load lock chamber 303 is opened, and the semiconductor wafer W is carried into the vacuum transfer chamber 301 by the vacuum transfer mechanism 302.

The semiconductor wafer W carried into the vacuum transfer chamber 301 is at first carried into the processing chamber 101 illustrated in FIG. 1 under a state in which the not-illustrated opening/closing mechanism provided between the vacuum transfer chamber 301 and the gas processing apparatus 100 (processing chamber 101) is opened to be mounted on the stage 102. Here, the by-product removal process is performed for the semiconductor wafer W.

The by-product removal process at the gas processing apparatus 100 is performed as described below. Namely, in the by-product removal process, the not-illustrated opening/closing mechanism is closed after the transfer arm of the vacuum transfer mechanism 302 retreats. The semiconductor wafer W becomes a state in which it is maintained at a predetermined temperature by mounting the semiconductor wafer W on the stage 102 set at the predetermined temperature in advance. The predetermined processing gas (the HF gas in this embodiment) is introduced from the gas introducing part 103 under this state, and the exhaust is performed from the exhaust pipe 107, and thereby, inside the processing chamber 101 becomes a processing gas atmosphere at a predetermined pressure.

The temperature of the semiconductor wafer W at the by-product removal process is, for example, several dozen degrees (for example, 20° C. to 40° C.), the pressure is, for example, several dozen Pa to several thousand Pa (for example, several hundred mTorr to several dozen Torr), a processing gas flow rate is, for example, at approximately several hundred sccm to a thousand and several hundred sccm, and a processing time is, for example, for approximately several dozen seconds to several minutes. This by-product removal process makes it possible to remove the by-product of which main constituent is SiO generated at the plasma etching process. However, after this by-product removal process is performed, the semiconductor wafer W becomes a state in which fluorine remains because the HF gas is used. If the semiconductor wafer W is left for a long time under a state in which fluorine remains, a defect occurs in the pattern because the residual fluorine reacts with silicon.

After the by-product removal process at the gas processing apparatus 100 is finished, the semiconductor wafer W is carried out of the gas processing apparatus 100 by the vacuum transfer mechanism 302, and carried into the processing chamber 201 of the plasma processing apparatus 200 via the vacuum transfer chamber 301. Namely, the semiconductor wafer W is mounted on the stage 202 inside the processing chamber 201 illustrated in FIG. 2 under a state in which the not-illustrated opening/closing mechanism provided between the vacuum transfer chamber 301 and the plasma processing apparatus 200 (the processing chamber 201) is opened. The residual fluorine removal process is performed as described below by the plasma processing apparatus 200.

In this residual fluorine removal process, the not-illustrated opening/closing mechanism is closed after the transfer arm of the vacuum transfer mechanism 302 retreats from the processing chamber 201. The semiconductor wafer W becomes a state in which it is maintained at a predetermined temperature by mounting the semiconductor wafer W on the stage 202 set at the predetermined temperature in advance. The predetermined cleaning gas (H₂+CH₄+Ar in this embodiment) is introduced from the gas introducing part 205 under this state, and the exhaust is performed from the exhaust pipe 207, and thereby, inside the processing chamber 201 is maintained at a predetermined pressure.

At the same time, high-frequency power is applied to the RF coil 204, and thereby, the plasma P of the cleaning gas is generated. This plasma P is maintained at a space between the gas diffusion plate 206 and the window 203 by the gas diffusion plate 206, and the radical extracted from the plasma P acts on the semiconductor wafer W, and fluorine remaining on the semiconductor wafer W is removed to be HF by, for example, a reaction with H₂.

At this time, if plasma of only H₂ is used as a conventional method, the portion of the exposing silicon layer is etched within the pattern formed on the surface of the semiconductor wafer W, and the pattern is damaged. FIG. 6 is a view schematically illustrating an example in which the portion of the silicon layer is etched and the pattern is damaged, and the damage such as cracks occurs at the exposed portion of the silicon layer as illustrated in FIG. 6.

On the other hand, in the present embodiment, CH₄ gas being a chemical compound containing carbon and hydrogen as constituent elements is contained in the cleaning gas, and therefore, it is possible to suppress the etching of the part of the silicon layer as stated above, and to suppress that the pattern formed on the semiconductor wafer W is damaged. This can be estimated because SiC is formed at the surface of the exposed part of the silicon layer, and SiC acts as a protective layer. This point can be ensured by a measurement result described below.

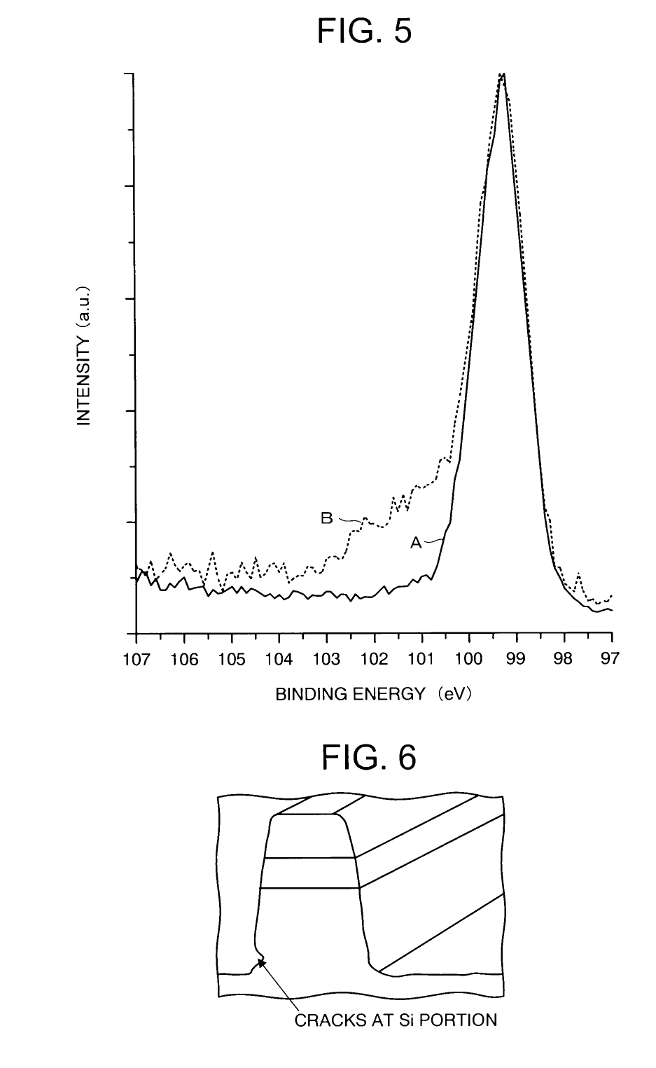

FIG. 5 is a graphic chart illustrating results in which the semiconductor wafer W (solid line A) after only the by-product removal process is performed and the semiconductor wafer W (dotted line B) in which the residual fluorine removal process is performed after the by-product removal process is performed are measured by XPS (X-ray photoelectron spectrum) while setting a vertical axis as intensity, and a horizontal axis as binding energy. High peaks commonly appear in both of the solid line A and the dotted line B in FIG. 5 are peaks representing the binding energies between silicon and silicon. In the dotted line B, it turns out that the intensity of a bottom part at a side of which binding energy is higher than this peak (represents the binding energy between Si and C) is high, because SiC is formed. When SiC is formed on the surface Of the silicon as stated above, it is possible to perform ashing with oxygen to change SiC into SiO to transfer it to the next process.

In the above-stated residual fluorine removal process, it is possible to enhance the removal efficiency of fluorine because fluorine is removed as gas such as CHF₃ because CH₄ exists. As stated above, CH₄ has a removal effect of fluorine, and therefore, when the semiconductor wafer W can be heated up to high temperature, it is also possible to perform the residual fluorine removal process by using the cleaning gas only containing CH₄ and rare gas such as Ar without adding H₂ while avoiding that deposit occurs by heating the semiconductor wafer W at high temperature. However, in many cases, it is not desirable to heat the semiconductor wafer W at high temperature.

When the residual fluorine removal process at the plasma processing apparatus 200 is completed, the semiconductor wafer W is carried out of the plasma processing apparatus 200 by the vacuum transfer mechanism 302, and carried into the load lock chamber 303 via the vacuum transfer chamber 301. The semiconductor wafer W is carried out into the atmosphere by the transfer mechanism 304 via the load lock chamber 303, and housed in the FOUP 306 mounted on the load port 307.

As an example, the by-product removal process was performed at the gas processing apparatus 100, and then, the residual fluorine removal process was performed by the plasma processing apparatus 200.

Processing conditions in the by-product removal process were:
pressure=1330 Pa (10 Torr);
HF gas=2800 sccm;
stage Temperature=30° C.; and
processing time=60 seconds.
Besides, processing conditions in the residual fluorine removal process were:
pressure=133 Pa (1 Torr);
cleaning gas=4 vol % H₂/Ar=1700 sccm+CH₄ (5 sccm);
high frequency power=200 W (27 MHz);
stage temperature=80° C.; and
processing time=10 minutes.

In the present example, a residual fluorine amount could be reduced to 2.9×10¹² atoms/cm² after the residual fluorine removal process whereas the fluorine residual amount before the residual fluorine removal process was 5.7×10¹³ atoms/cm², and the damage caused by the etching of the silicon layer was not found when the pattern was observed by an electron microscope.

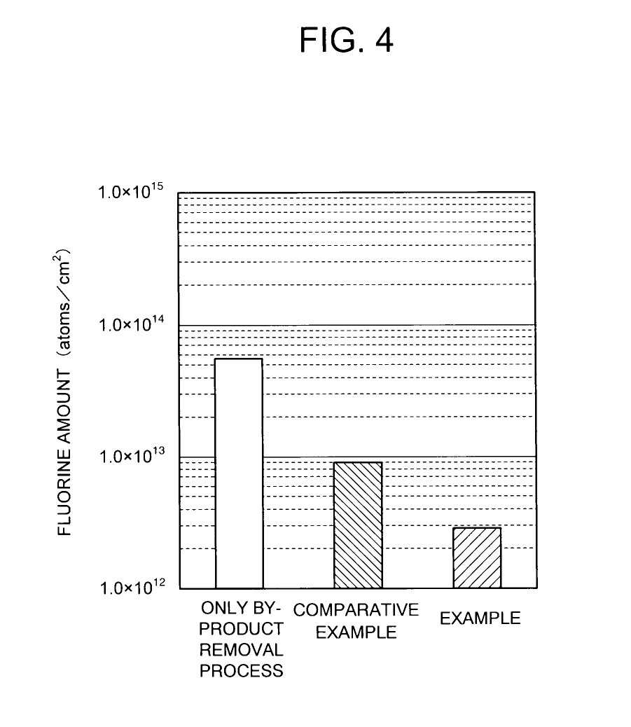

As a comparative example, when the residual fluorine removal process was performed by processing gas to which CH₄ was not added, the damage of the pattern caused by the etching of the silicon layer was observed when the high frequency power was set at 50 W. Besides, the damage of the pattern caused by the etching of the silicon layer was not observed when the high frequency power was set at 25 W, but the residual fluorine amount after the residual fluorine removal process became 9.1×10¹² atoms/cm², and the removal effect of fluorine obviously inferior to the example. Note that the other conditions were the same as the case of the above-stated example. The measurement results of the residual fluorine of the example, the comparative example, and before the residual fluorine removal process (only the by-product removal process) are represented by a bar graph in FIG. 4 in which a vertical axis is set to a fluorine amount.

As stated above, in the example it was possible to perform the by-product removal and the residual fluorine removal without damaging the pattern when the pattern including the exposed part of the silicon layer is formed by the plasma etching.

Note that it goes without saying that the present invention is not limited to the above-stated embodiments and examples, and various modifications can be available. For example, a parallel plate type and capacitive coupling type plasma processing apparatus and so on can be used as the plasma processing apparatus used for the residual fluorine removal process, other than an inductively coupled type apparatus using remote plasma. In this case, for example, the high frequency power for plasma generation may be supplied only to an upper electrode so that the plasma acts on a semiconductor wafer mounted On a lower electrode. Besides, for example, CH₃OH gas and so on can be used as the chemical compound gas containing carbon and hydrogen as constituent elements used for the residual fluorine removal process, instead of CH₄ gas.

The embodiments of the present invention can be expanded or changed within the technical scope of the present invention, and it is to be understood that all the expanded and changed embodiments are to be included therein.

What is claimed is:

1. A substrate cleaning method performing cleaning of a surface of a substrate after a pattern on the substrate is formed by plasma etching, comprising:
performing a by-product removal process removing a by-product by exposing the substrate to an HF gas atmosphere; and
performing a residual fluorine removal process removing fluorine remaining on the substrate by turning cleaning gas containing hydrogen gas and chemical compound gas containing carbon and hydrogen as constituent elements into plasma to act on the substrate.

2. The substrate cleaning method according to claim 1,
wherein the chemical compound gas containing carbon and hydrogen as the constituent elements is CH₄ gas or CH₃OH gas.

3. The substrate cleaning method according to claim 1,
wherein the cleaning gas further contains rare gas.

4. The substrate cleaning method according to claim 3,
wherein the rare gas is Ar gas.

5. The substrate cleaning method according to claim 1,
wherein the cleaning gas contains hydrogen gas of 4 vol % or less.

6. The substrate cleaning method according to claim 1,
wherein the pattern on the substrate is the pattern including an exposed part of a silicon layer.

7. The substrate cleaning method according to claim 6,
wherein a layer made up of SiC is formed on a surface of the exposed part of the silicon layer at the residual fluorine removal process.

8. The substrate cleaning method according to claim 2,
wherein the cleaning gas further contains rare gas.

9. The substrate cleaning method according to claim 8,
wherein the rare gas is Ar gas.

10. The substrate cleaning method according to claim 2,
wherein the cleaning gas contains hydrogen gas of 4 vol % or less.

11. The substrate cleaning method according to claim 2,
wherein the pattern on the substrate is the pattern including an exposed part of a silicon layer.

12. The substrate cleaning method according to claim 11,
wherein a layer made up of SiC is formed at a surface of the exposed part of the silicon layer at the residual fluorine removal process.

13. A substrate cleaning apparatus performing cleaning of a surface of a substrate after a pattern on the substrate is formed by plasma etching, comprising:
a by-product removal unit removing a by-product by exposing the substrate to an HF gas atmosphere; and
a residual fluorine removal unit removing fluorine remaining on the substrate by turning cleaning gas containing hydrogen gas and chemical compound gas containing carbon and hydrogen as constituent elements into plasma to act on the substrate.

14. The substrate cleaning apparatus according to claim 13,
wherein the pattern on the substrate is the pattern including an exposed part of a silicon layer.
